(19) United States
(12) Patent Application Publication
(10) Pub. No.: US 2011/0048956 A1
(43) Pub. Date: Mar. 3, 2011

(54) ELECTRODEPOSITION METHOD FOR THE PRODUCTION OF NANOSTRUCTURED ZNO

(75) Inventors: Jie Chen, Berlin (DE); Lorenz Ae, Bamberg (DE); Christian-Herbert Fischer, Berlin (DE); Martha Christina Lux-Steiner, Berlin (DE)

(73) Assignee: HELMHOLTZ-ZENTRUM BERLIN FÜR MATERIALIEN UND ENERG, Berlin (DE)

(21) Appl. No.: 12/918,747

(22) PCT Filed: Feb. 20, 2009
(86) PCT No.: PCT/DE2009/000254

§ 371 Date: Nov. 18, 2010

(30) Foreign Application Priority Data
Feb. 21, 2008 (DE) 10 2008 010 287.3
Jun. 19, 2008 (DE) 10 2008 029 234.6

(51) Int. Cl. C25D 7/12; C25D 5/00; B82Y 40/00

(52) U.S. Cl. 205/157; 205/333; 977/890

(57) ABSTRACT

The problem addressed by the invention is that of improving on an electrodeposition method for the production of nanostructured ZnO in such a manner that this method enables the production of nanostructured ZnO with a high internal quantum efficiency (IQE) without additional tempering steps. According to the invention, the electrodeposition method use an aqueous solution of a Zn salt, for example Zn(NO₃)₂, and a doping agent, for example HNO₃ or NH₄NO₃. ZnO nanotubes produced in this way show an intense emission band edge in the UV range and only a weak emission in the range from 450 to 700 nm in the photoluminescence spectrum.

### CROSS REFERENCE TO RELATED APPLICATIONS

This application is a U.S. National Phase application under 35 U.S.C. §371 of International Application No. PCT/DE2009/000254, filed on Feb. 20, 2009, and claims benefit to German Patent Application No. DE 10 2008 010 287.3, filed on Feb. 21, 2008 and German Patent Application No. DE 10 2008 029 234.6, filed on Jun. 19, 2008. The International Application was published in German on Aug. 27, 2009 as WO 2009/103286 A2 under PCT Article 21 (2).

### FIELD

The invention relates to an electrodeposition method for the production of nanostructured ZnO using a three-electrode reactor containing an aqueous solution of a Zn salt and another constituent.

### BACKGROUND

As set forth in this application, nanostructured ZnO material refers to ZnO having a morphology with dimensions in the nm range or smaller. In this context, the ZnO can be configured, for example, in the form of nanorods, nanowires, or thin layers. Owing to its optoelectronic and environmentally friendly properties as well as its chemical stability, ZnO is a very promising material for use in light-emitting diodes and in highly structured solar cells.

ZnO nanorods or nanowires are produced by means of various methods.

High deposition temperatures are typical of many of the conventional methods for producing ZnO nanorods. For instance, in the case of the CVD (chemical vapor deposition) method and the MOCVD (metal organic chemical vapor deposition) method, the temperatures lie between 300° C. and 500° C. [572° F. and 932° F.], while it is between 400° C. and 500° C. [752° F. and 932° F.] for the MOVPE (metal organic vapor phase epitaxy) process, 600° C. to 900° C. [1112° F. to 1652° F.] for the vapor-transport method and approximately 900° C. [1652° F.] in the case of thermal evaporation. The VLS (vapor-liquid-solid) technique makes use of temperatures above 900° C. [1652° F.].

In contrast to this, materials are deposited at moderate temperatures by means of an electrodeposition method and chemical bath deposition.

The electrodeposition method is carried out not only at the above-mentioned low deposition temperatures, but also at atmospheric pressure, and it is a low-cost method that requires only simple equipment. The film thickness can be ascertained on the basis of the charges used during the deposition process.

ZnO nanorods obtained by using the electrodeposition method are produced from an aqueous solution, for instance, a ZnCl₂/KCl electrolyte solution saturated with O₂ bubbles (as described, for example, in the 13^{th} European Photovoltaic Solar Cell Energy Conference, Oct. 23 to 27, 1995 in Nice, France, pp. 1750-1752, or in Appl. Phys. Lett., Vol. 77, No. 16, Oct. 16, 2000, pp. 2575-2577), or else ZnO films are produced from a ZnCl₂/H₂O₂ electrolyte solution as is described, for example, in the Journal of Electroanalytical Chemistry 517 (2001), 54-62. However, the nanostructured ZnO materials thus produced do not exhibit the properties needed for photovoltaic use such as, for instance, a high degree of efficiency, since the photoluminescence spectra recorded for these materials show a very intense defect emission in the range from 450 nm to 900 nm as the main emission.

It was likewise not possible to ascertain an improved photoluminescence spectrum for the ZnO nanorods produced by means of a wet-chemical method from a Zn(NO₃)₂/NaOH solution (see HMI Annual Report 2006, page 74, or Journal of the European Ceramic Society, Volume 26, Issue 16, 2006, pages 3745-3752), because the defect emission was observed here as well.

Small 2006, 2, No. 8-9, 944 ff., reports on measured results of photoluminescence spectra for various ZnO nanostructures. This method is also employed in the present approach for the characterization of the ZnO nanostructures produced.

When it comes to the use of nanostructured ZnO material in photonics or optoelectronics, it is advantageous to carry out an annealing process that reduces the defect emission in the visible light spectrum and increases the quality of the material.

In the dissertation by J. Reemts titled “Ladungstransport in farbstoffsensibilisierten porösen ZnO-Filmen” [Charge transport in dye-sensitized porous ZnO films] (the Carl von Ossietzky University of Oldenburg, 2006, page 21), it is ascertained that the ZnO films produced by means of electrodeposition in a zinc nitrate/KCl or zinc chloride/KCl solution have a typical structure of hexagonal columns. It was also found that the morphology of ZnO films made from a zinc chloride solution is considerably more reproducible than that of ZnO films made from the zinc nitrate solution.

In the dissertation by E. Michaelis titled “Darstellung von Photosensibilisatoren and elektrochemische Abscheidung von sensibilisierten nanostrukturierten Zinkoxidelektroden” [Preparation of photosensitizers and electrochemical deposition of sensitized nanostructured zinc oxide electrodes] (University of Bremen, 2005, page 35), it is ascertained that the morphology of ZnO films deposited from a resting zinc nitrate solution can be influenced by varying the potential that is applied.

U.S. Pat. No. 6,160,689 A, EP 1 420 085 A2 and EP 0 794 270 A1 also describe the method of electrochemical deposition from a solution containing at least Zn²⁺ and NO₃⁻ ions in order to form a ZnO film. In U.S. Pat. No. 6,160,689 A, the ions are provided either in an aqueous solution of Zn(NO₃)₂ or in a mixture consisting of NH₄NO₃ and ZnSO₄. In addition to citing the Zn²⁺ and NO₃⁻ ions, EP 1 420 085 A2 also mentions polyvalent carboxylic acid as an additional constituent of the solution, while EP 0 794 270 A1 cites carbohydrates.

### SUMMARY

An aspect of the invention is to provide an electrodeposition method for the production of nanostructured ZnO whereby nanostructured ZnO material with a high internal quantum efficiency (IQE) can be produced without an additional annealing step.

In an embodiment, the present invention provides an electrodeposition method for the production of nanostructured ZnO. The method includes disposing an aqueous solution including a Zn salt and a doping agent in a three-electrode reactor. A potential is applied to an electrically conductive substrate disposed in the aqueous solution and a temperature is set below 90° C. so as to deposit nanostructured ZnO material on the electrically conductive substrate.

### BRIEF DESCRIPTION OF THE DRAWINGS

Exemplary embodiments of the invention are described in greater detail below in the embodiment, making reference to the drawings, in which:

FIG. 1 shows a photoluminescence spectrum of ZnO nanorods, produced by electrodeposition from Zn(NO₃)₂/H₂O₂ electrolytes, ZnCl electrolytes or Zn(NO₃)₂/NaOH electrolytes;

FIG. 2 show as a scanning electron microscope image of ZnO nanorods produced by a method according to an embodiment of the invention, with HNO₃ as the doping agent;

FIG. 3 shows a photoluminescence spectrum of ZnO nanorods according to FIG. 2;

FIG. 4 shows a scanning electron microscope image of ZnO nanorods with a modified morphology, produced by a method according to an embodiment the invention, with HNO₃ as the doping agent;

FIG. 5 shows a photoluminescence spectrum of ZnO nanorods according to FIG. 4;

FIG. 6 shows a photoluminescence spectrum of ZnO nanorods, with different diameters, produced by a method according to an embodiment of the invention, with HNO₃ as the doping agent.

### DETAILED DESCRIPTION

A method according to an embodiment of the invention may improve the quality and the optical properties of the ZnO material.

In an embodiment of the invention, Zn(NO₃)₂ is used as the Zn salt, especially at a concentration ranging from 1 mM to 20 mM.

Additional embodiments relate to the use of HNO₃, NH₄NO₃ or NH₃ dissolved in water as the doping agent.

If HNO₃ is used as the doping agent, the aqueous solution may be made on the basis of Zn(NO₃)₂ and HNO₃ at a molar ratio of approximately 100:1, whereby this solution has a pH value between 4.5 and 5.8.

It is known that ZnO is not stable in concentrated HNO₃, which probably also gives rise to the determination that ZnO films made from a zinc nitrate solution are not as reproducible as those made from a zinc chloride solution, which has already been described in the above-mentioned dissertation by J. Reemts at the Carl von Ossietzky University of Oldenburg, 2006. Nevertheless, it was found that, in the present method, the NO₃⁻ ions serve as an oxidant for the growth of pure ZnO. The HNO₃ constituent in the electrolyte solution raises the H⁺ concentration in the solution and reduces the defect emission in the visible light spectrum, thus improving the optical quality of the nanostructured ZnO material thus produced.

When NH₄NO₃ is employed as the doping agent, the aqueous solution may be made of Zn(NO₃)₂ and NH₄NO₃ at a molar ratio ranging from 1:1 to 130:1, whereby this solution has a pH value between 4.2 and 6.4.

It has been found that the production of nanostructured ZnO material using a dissolved salt as the second constituent of the solution and also a doping agent at the indicated ratio leads to equally good results as when HNO₃ is used.

On the basis of current knowledge, the following reactions take place in the solution:

Zn(NO₃)₂→Zn²⁺+2NO₃⁻

NO₃⁻+2e⁻+H₂O→2OH⁻+NO₂⁻

Zn²⁺+2OH⁻→Zn(OH)₂

Zn(OH)₂→ZnO+H₂O

Moreover, the following reaction takes place in the solution:

8H⁺+NO₃⁻+8e⁻→NH₃+OH⁻+2H₂O

Since the latter reaction also takes place in the aqueous solution, it is conceivable to use NH₃ dissolved in water as the doping agent. This reaction is locally limited and only occurs on the growing ZnO nanostructures.

With the method of the invention it is possible to produce ZnO nanorods having an average diameter of 100 nm to 280 nm by combining potentiostatic and galvanostatic processes. As desired and without an additional annealing step, the ZnO nanorods exhibit a dominating band edge emission and have a large IQE that lies at 23% and 28% for the first ZnO nanorods that are deposited using this method. For various nanorod forms, the measured high IQE exhibited deviations ranging from 20% to 25%. In this manner, it was possible to confirm that the method makes it possible to properly adjust and control the surface morphology and the diameter of the ZnO nanorods—without any significant effect on the IQE—by changing the applied potential and the molarity of the solution and, as mentioned above, now even without an additional annealing process.

The IQE is one of the most important parameters for the characterization of the quality of light-emitting as well as optoelectronic material. It is defined as the ratio of the number of generated photons to the number of injected charge carriers. The following generally applies: the fewer the defects in the material, the higher the IQE.

In another embodiment, a potential having a value between −1.2 V and −1.8 V, preferably between −1.3 V and −1.4 V, is set at the Pt reference electrode.

Moreover, it is provided that the deposition temperature is set between 60° C. and 90° C. [140° F. and 194° F.] and maintained over a duration of a few minutes up to 20 hours.

In an embodiment, the solution may be stirred be stirred during the deposition.

Depending on the area of application of the method, different materials can be used as the substrate; in particular the following are provided: FTO (SnO₂:F), ITO (SnO₂:In), Au, Ag, a polymer with a conductive coating or Si.

In an embodiment of the invention, a glass substrate with a fluorine-doped SnO₂ layer (so-called FTO glass) is employed as the substrate, on which an undoped 30 nm-thick ZnO layer is arranged. The substrate measures about 2.5 cm×2 cm, and it is first purified in an ultrasound bath (acetone and ethanol), followed by rinsing in distilled water. The ZnO is deposited onto the substrate in an electrochemical cell with three electrodes (working electrode=substrate; counterelectrode=Pt; reference electrode=Pt). For this purpose, this cell is placed in a temperature-controlled bath and the deposition temperature is set at 75° C. [167° F.]. An aqueous solution consisting of 10 mM Zn(NO₃)₂ and HNO₃ with a pH value of 4.5 is employed at a mixing ratio of 100:1 for the deposition. The solution is stirred during the deposition. For the deposition of ZnO nanorods on the above-mentioned substrate, a potential of −1.4 V is set at the Pt reference electrode and maintained for 8000 seconds. Typical deposition current densities in the method according to the invention are about 0.3 mA/cm² to 0.5 mA/cm². In order to remove excess salt, the substrate with the applied ZnO nanorods is washed with distilled water.

A very uniform deposition of ZnO nanorods over the entire substrate surface was observed.

The morphology of the generated layers consisting of ZnO nanorods was examined using a scanning electron microscope (SEM).

Photoluminescence measurements were carried out at an excitation wavelength of 325 nm (He—Cd laser).

The n-conductivity of the ZnO nanorods was determined in other temperature-dependent photoluminescence measurements which, as already mentioned, served to ascertain the IQE.

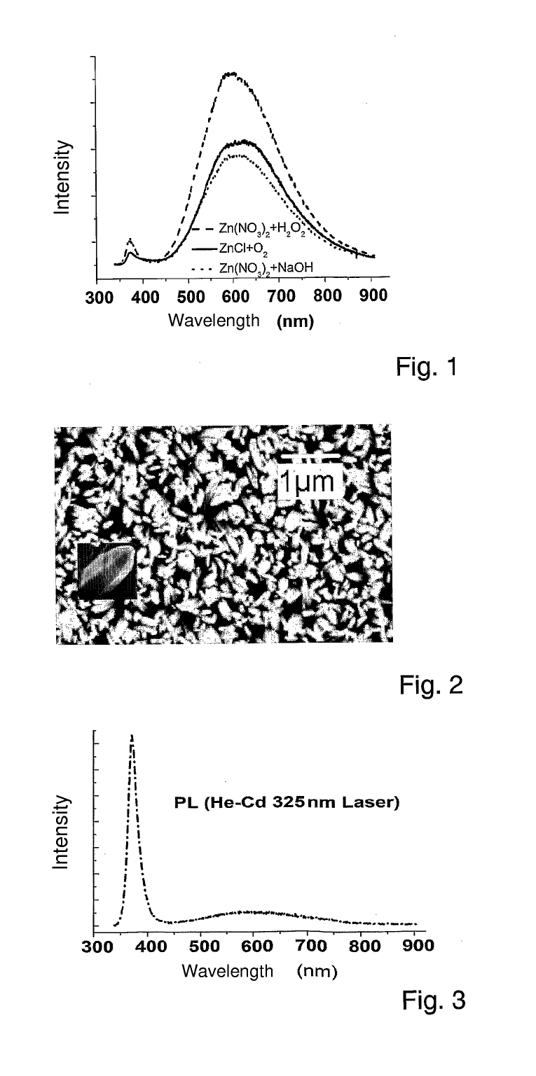

FIG. 1 shows ascertained photoluminescence spectra of ZnO nanorods that were produced on an FTO glass substrate by means of an electrodepostion method that made use of the electrolyte solutions (Zn(NO₃)₂/H₂O₂, Zn(NO₃)₂/NaOH, ZnCl) known from the state of the art. The strong defect emission is clearly the most important emission and indicates poor quality of the ZnO nanorods.

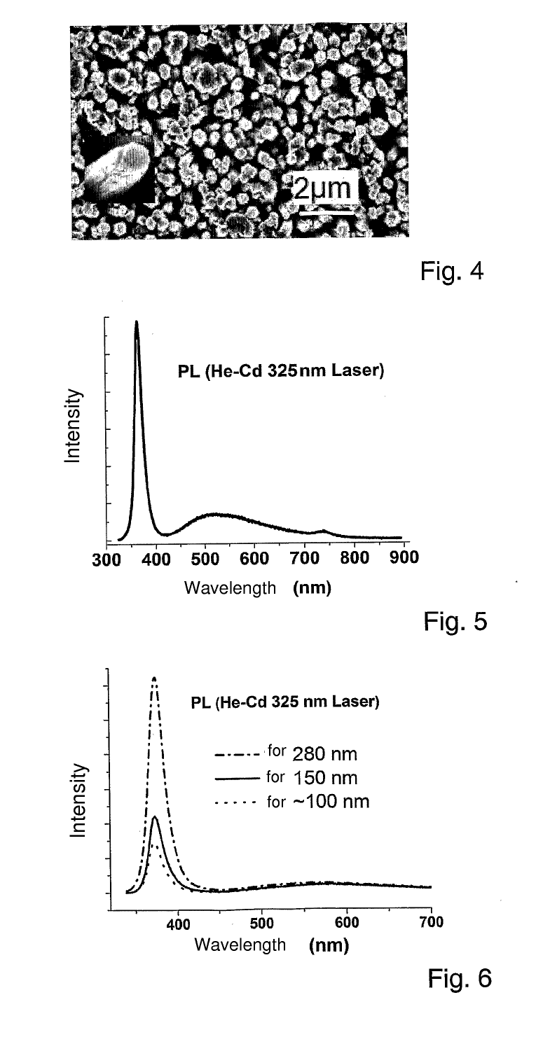

FIGS. 2 and 4 show images of the ZnO nanorods having different shapes produced by the method according to an embodiment of the invention with HNO₃ as the doping agent. The different shapes are based on different potentials and molarity values of the electrolyte solution. An IQE of approximately 28% was determined for the ZnO nanorods shown in FIG. 2 and of 23% for those of FIG. 4.

The corresponding photoluminescence spectra at room temperature are shown in FIGS. 3 and 5. Both spectra exhibit a very intense band edge emission in comparison to the defect emission. The maximum at about 375 nm is ascribed to the ZnO structure.

FIG. 6 shows photoluminescence spectra at room temperature for ZnO nanorods having differing diameters ranging from about 100 nm to 280 nm. The various diameters were also realized by combining potentiostatic and galvanostatic techniques. It is clearly possible to see the position of the intense maximum for the band edge emission in the UV spectrum and only a weak emission in the range from 450 nm to 700 nm, in other words, the shape of the ZnO nanorods produced by means of a method according to an embodiment of the invention has no effect on their defect emission.

The intensities of the photoluminescence spectra were indicated in the figures in arbitrary units.

In another embodiment, 10 mM Zn(NO₃)₂ and NH₄NO₃ with a pH value of 4.8 at a mixing ratio of 20:1 are employed as the doping agents and thus as additional constituents of the aqueous solution for purposes of the deposition of nanostructured ZnO. All of the other information for the execution of the method remains unchanged.

A REM image very similar to that of FIG. 2 was also obtained for this nanostructured ZnO deposited in the second embodiment. An IQE of about 35% was determined for the produced ZnO nanorods. FIG. 3 also matches the result in the second embodiment.

For the method according to the embodiment with NH₄NO₃ as the additional constituent of the aqueous solution, the ratio of Zn(NO₃)₂ to NH₄NO₃ was changed and the work function and the IQE were ascertained in each case. The result, depicted in the table below, shows the change in the work function and in the IQE as a function of the cited ratio.

| Sample | Zn(NO₃)₂/NH₄NO₃ | Work function | IQE |
|---|---|---|---|
| 1 | 7 mM/500 μM | 4.3 eV ± 0.15 eV | 24% |
| 2 | 7 mM/1 mM | 4.5 eV ± 0.15 eV | 20% |
| 3 | 7 mM/5 mM | 4.8 eV ± 0.15 eV | 20% |

It has been shown that the doping agents create the possibility of systematically changing the work function of the nanostructured ZnO material, without this significantly affecting its quality and its optical properties.

While the invention has been particularly shown and described with reference to preferred embodiments thereof, it will be understood by those skilled in the art that various changes in form and details may be made therein without departing from the spirit and scope of the invention.

1-15. (canceled)

16. An electrodeposition method for the production of nanostructured ZnO, the method comprising:
disposing an aqueous solution comprising a Zn salt and a doping agent in a three-electrode reactor; and
applying a potential to an electrically conductive substrate disposed in the aqueous solution and setting a temperature at a value below 90° C. so as to deposit nanostructured ZnO material on the electrically conductive substrate.

17. The electrodeposition method as recited in claim 16, wherein the Zn salt includes Zn(NO₃)₂.

18. The electrodeposition method as recited in claim 17, wherein the Zn(NO₃)₂ has a concentration ranging from 1 mM to 20 mM.

19. The electrodeposition method as recited in claim 16, wherein the doping agent includes HNO₃.

20. The electrodeposition method as recited in claim 17, wherein the doping agent includes HNO₃ and the molar ratio of Zn(NO₃)₂ to HNO₃ is approximately 100:1.

21. The electrodeposition method as recited in claim 20, wherein the aqueous solution has a pH value between 4.5 and 5.8.

22. The electrodeposition method as recited in claim 16, wherein the doping agent includes NH₄NO₃.

23. The electrodeposition method as recited in claim 17, wherein the doping agent includes NH₄NO₃ and the molar ratio of Zn(NO₃)₂ to NH₄NO₃ is in a range from 1:1 to 130:1.

24. The electrodeposition method as recited in claim 23, wherein the aqueous solution has a pH value between 4.2 and 6.4.

25. The electrodeposition method as recited in claim 16, wherein the doping agent includes NH₃ dissolved in water.

26. The electrodeposition method as recited in claim 16, wherein the potential has a value between −1.2 V and −1.8 V set at a Pt reference electrode of the three-electrode reactor.

27. The electrodeposition method as recited in claim 16, wherein the temperature is set between 60° C. and 90° C.

28. The electrodeposition method as recited in claim 16, wherein the temperature is maintained over a duration of between a few minutes and 20 hours.

29. The electrodeposition method as recited in claim 16, further comprising stirring the aqueous solution during the deposition.

30. The electrodeposition method as recited in claim 16, wherein the electrically conductive substrate includes at least one of FTO, ITO, Au, Ag, a polymer with a conductive coating and Si.
